(19) United States
(12) Patent Application Publication
(10) Pub. No.: US 2006/0057545 A1
(43) Pub. Date: Mar. 16, 2006

(54) Pronunciation training method and apparatus

(75) Inventors: Forrest S. Mozer, Berkeley, CA (US); Robert E. Savoie, Los Altos Hills, CA (US); Roi Nelson Peers JR., Castro Valley, CA (US)

Correspondence Address: Fountainhead Law Group, Suite 509, 900 Lafayette Street, Santa Clara, CA, 95050, US

(73) Assignee: Sensory, Incorporated, Santa Clara, CA (US)

(21) Appl. No.: 10/940,164

(22) Filed: Sep. 14, 2004

(51) Int. Cl. G09B 19/00

(52) U.S. Cl. 434/156

(57) ABSTRACT

Embodiments of the present invention include a computer-implemented pronunciation training method comprising receiving a spoken utterance from a user, the spoken utterance including a plurality of sub-units of sound, analyzing the speech quality of the plurality of sub-units of sound of the spoken utterance and generating an audio signal of the spoken utterance from the user while simultaneously displaying the speech quality of each sub-unit of the spoken utterance as each sub-unit of the spoken utterance is generated.

### BACKGROUND OF THE INVENTION

This invention relates to speech training, and in particular, to techniques for training non-native speakers of a language the meaning and/or pronunciation of phrases in a given language.

With the development of digital technologies, high tech methods of teaching the meaning and pronunciation of phrases in a given language have come into wide use. These technologies include methods that both do and do not require a relatively expensive apparatus such as a personal computer. Additionally, there are devices that either use or do not use speech recognition as part of the learning strategy.

Typical examples of devices that require a relatively expensive electronic apparatus such as a personal computer and that do not use speech recognition in the learning experience include the following:
1) U.S. Pat. No. 6,729,882, which describes a computer-based system for teaching the sound patterns of English using visual displays of phonetic patterns and pre-recorded speech output.
2) U.S. Pat. No. 6,726,486, which describes a computer-based system for training students to decode words into a plurality of category types using graphical methods.
3) U.S. Pat. No. 6,296,489, which describes a system for displaying a model sound superimposed over a waveform or spectrogram of the user's sound input.
4) U.S. Pat. No. 5,557,706 is a recorder/player that allows a user to listen to model sounds and to record his version for comparison with the pre-recorded sounds through listening to both.
5) An audio CD system from TOPICS Entertainment provides pronunciations of English phrases for 8 different situations (meeting new people, buying a car, etc.) and asks the user to learn pronunciation by listening to the recordings of the phrases.
6) CAPT, the Computer Assisted Pronunciation Trainer of The Natural Interactive Systems Laboratory at the University of Southern Denmark allows the user to hear, practice and compare his speech with that of a professional recording.
7) Honda Electronics uses a tongue motion monitoring system that allows a speaker to compare the location and placement of his tongue and lips with that of an expert on single phonemes.
8) Tal-Shahar Alef Bet Trainer is a CD-ROM that teaches reading and pronunciation of letters, vowels, etc. with no feedback for the user.

Typical examples of devices that require a relatively expensive apparatus such as a personal computer and that do include speech recognition in the learning experience include:
1) The Fluency Pronunciation Trainer of the Language Technologies Institute, Carnegie Mellon University, Pittsburgh, Pa. USA. This trainer uses the CMU SPHINX II automatic speech recognizer to determine what sentence a user spoke from a small group of alternatives and what the phone duration, intensity and pitch of the users phrase was. It does not determine the phonemic correctness of the phrase and the user feedback is numbers or one of a pair of words such as LONG or SHORT.
2) Syracuse Language Systems Accent Coach, which uses the IBM ViaVoice speech recognizer to compare intonation with that of a professional voice. The feedback consists of plots of the user's intonation and the intonation of the professional voice, plots of the location of the user's vowel pronunciation on an f1 versus f2 diagram, and side views of the mouth showing the locations of the tongue and lips for specific sounds.

Currently, there are no handheld, inexpensive devices on the market that employ speech recognition to offer feedback to the user on the quality of pronunciation. BBK, TCL, JF, and SOCO are Asian companies that offer language assistance products in the price range of $25.00 to $95.00. They are all record-and-playback devices that offer different levels of playback control, none of which provide information to the user other than his original recording. Some also contain electronic Chinese/English dictionaries.

In the price range to $400.00, Global View, Lexicomp, Golden, GSL, Minjin and BBK offer models that are also record and playback devices. They allow storage of larger recordings, and some contain speech recordings by professional voices that allow a user to make his own audio comparison of his recording with that of a professional voice. None of these devices provide evaluation and feedback on the quality of the user's recording.

Current art pronunciation trainers, such as those described above, suffer from two drawbacks. First, many of them require use of a complicated apparatus such as a personal computer. Many potential students either do not have access to personal computers or have access to them only in classrooms. Pronunciation training is better done in private as compared to in a classroom environment because the latter may be embarrassing to the individual and correcting individuals upsets the normal pace of classroom activity.

The second deficiency of current art pronunciation trainers is that feedback to the user is either non-existent or is offered in ways that many users have difficulty assimilating. These include graphs of formant frequencies, scores given as numbers, and pictures of the placement of the tongue and lips for correct pronunciation.

### SUMMARY OF THE INVENTION

Embodiments of the present invention include a computer-implemented pronunciation training method comprising receiving a spoken utterance from a user, the spoken utterance including a plurality of sub-units of sound, analyzing the speech quality of the plurality of sub-units of sound of the spoken utterance and generating an audio signal of the spoken utterance from the user while simultaneously displaying the speech quality of each sub-unit of the spoken utterance as each sub-unit of the spoken utterance is generated.

In one embodiment, the present invention provides an electronic device that teaches the elements of correct pronunciation through use of a speech recognizer that evaluates the prosody, intonation, phonetic accuracy and lip and tongue placement of a spoken phrase.

In accordance with one embodiment of the invention, the user may practice pronunciation in private because the pronunciation trainer is an inexpensive, hand-held, battery operated device.

In accordance with another embodiment of the invention, feedback on prosody, intonation, and phonetic accuracy of a user's spoken phrases are provided through an intuitive visual means that is easy for a non-technical person to interpret.

In accordance with another embodiment of the invention, the user may listen to his recording while observing the visual feedback in order to learn where pronunciation errors were made in a phrase.

In accordance with another embodiment of the invention, the recording of the user can be played back at slow speed while the user observes the visual feedback in order for the user to better identify the location of pronunciation errors in a phrase.

In accordance with another embodiment of the invention, the user can compare his recording with that of a professional voice to learn the correct pronunciation of those parts of phrases that he learned from the visual feedback were not well-spoken.

In accordance with another embodiment of the invention, the user can set the level of the analysis of his speech in order to increase the subtlety of the analysis as his proficiency improves.

In accordance with another embodiment of the invention, the electronic device that teaches pronunciation may be used without modification by speakers having different native tongues because a small instruction manual in the language of the speaker provides all the information required for the speaker to operate the electronic device.

In accordance with another embodiment of the invention, the visual means used to provide pronunciation feedback is also used as a signal level indicator during recordings in order to guarantee an appropriate signal amplitude.

In accordance with another embodiment of the invention, the background noise level is monitored by the electronic device and the user is alerted whenever the signal-to-noise ratio is too low for a reliable analysis by the speech recognizer.

In accordance with another embodiment of the invention, the performance of the speech recognizer is improved by normalizing its output according to the mean and standard deviation of the outputs from a corpus of good speakers saying the phrases being studied.

The following detailed description and accompanying drawings provide a better understanding of the nature and advantages of the present invention.

### BRIEF DESCRIPTION OF THE DRAWINGS

FIG. 1A illustrates a pronunciation training method according to one embodiment of the present invention.

FIG. 1B illustrates an apparatus according to one embodiment of the present invention.

FIG. 2 shows an example utterance and sub-units for the utterance “how are you.”

FIG. 3 illustrates simultaneous display and playback according to one embodiment of the present invention.

FIG. 4 illustrates a pronunciation training method according to one embodiment of the present invention.

FIG. 5 illustrates a hand-held pronunciation trainer according to one embodiment of the present invention.

FIG. 6 is the output of a speech recognizer for the well-spoken phrase “Please say that again” according to one specific example implementation.

FIG. 7 is the output of a speech recognizer for the poorly-spoken phrase “Please say that again” according to one specific example implementation.

FIG. 8 is the average scores from the data of FIG. 7.

FIG. 9 is a scoring table that may be used in displaying speech quality in one specific example implementation.

### DETAILED DESCRIPTION

Described herein are techniques for implementing pronunciation training. In the following description, for purposes of explanation, numerous examples and specific details are set forth in order to provide a thorough understanding of the present invention. It will be evident, however, to one skilled in the art that the present invention may be practiced without these examples and specific details. In other instances, certain methods and processes are shown in block diagram form in order to avoid obscuring the present invention. Furthermore, while the present invention may be used for pronunciation training in any language, the present description uses English. However, it is recognized that any language may be taught using the methods and devices described in this disclosure.

There are basically two properties to proper speech: the sounds and how those sounds are spoken. Words or phrases spoken by a user are referred to herein as “utterances.” Utterances may be broken down into sub-units for more detailed analysis. One common example of this is to break an utterance down into phonemes. Phonemes are the sounds in an utterance, and thus represent the first of the two properties mentioned above. The second property is how the sounds are spoken. The term used herein to describe “how” the sounds are spoken is “prosody.” Prosody may include pitch contour as a function of time and emphasis. Emphasis may include the volume (loudness) of the sounds as a function of time, the duration of the various sub-units of the utterance, the location or duration of pauses in the utterance or the duration of different parts of each utterance.

Proper pronunciation involves speaking the phonemes (sounds) of the language correctly and using the correct prosody (i.e., where by “correct” means according to local, regional or business customs, which may be programmable). As used herein, the term “speech quality” refers to the sounds and prosody of a user's utterance. For example, speech quality may be improved by minimizing the difference between the sound and prosody of a reference utterance and the sound and prosody of a user's utterance.

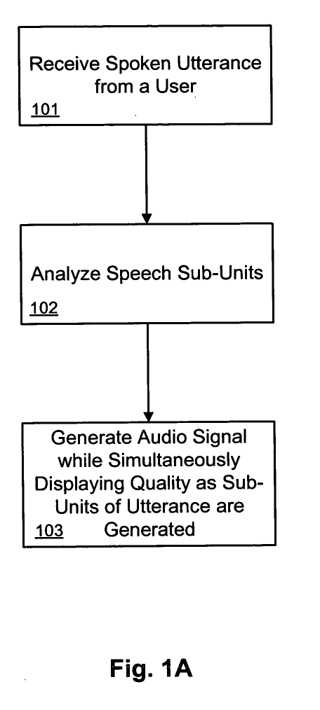

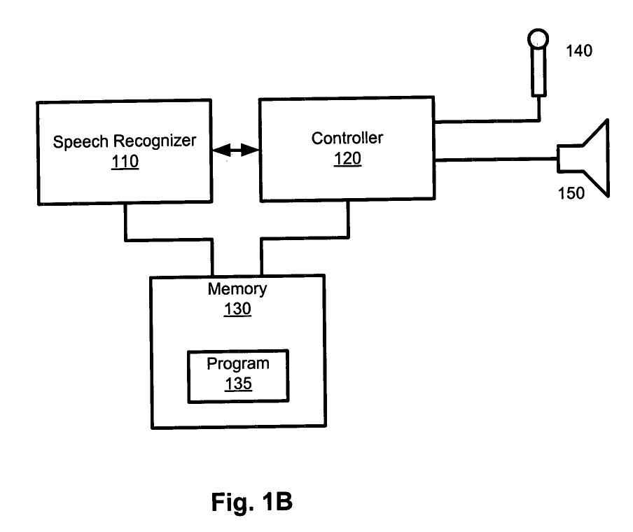

FIG. 1A illustrates a pronunciation training method according to one embodiment of the present invention. The method may be implemented on a computer based system such as a personal computer, personal digital assistance (“PDA”), cell phone or other portable or hand held device. At step 101, the system receives a spoken utterance from a user. For example, the utterance may be spoken by the user and captured using a microphone. The utterance may then be converted from an analog signal into a digital signal for processing by the system. At step 102, the system analyzes speech sub-units. For example, rather than analyzing the utterance as a whole, the system may analyze the utterance in segments (e.g., according to time). In another example, the system breaks the utterance in to sub-units according the phonemes in the utterance, wherein each sub-unit corresponds to a phoneme. At step 103, the system generates an audio signal (i.e., plays back the recorded speech) while simultaneously displaying the speech quality as sub-units of the utterance are generated. For example, as described in more detail below, as the utterance is played back the user is given an indication of the speech quality of the part of the utterance that is being generated at that moment. If the utterance were “where is the train station,” for example, the system will display the speech quality of “train” at about the same time as “train” is played back so the user will know which part of the utterance was pronounced properly and which part was not. Thus, as the user hears a part of an utterance, the user has immediate feedback on the speech quality of the part of the utterance that he/she is hearing.

FIG. 1B illustrates an apparatus according to one embodiment of the present invention. Embodiments of the present invention may include an apparatus for pronunciation training. The apparatus may be implemented in a personal computer or as a hand-held or portable device. The apparatus may include a microphone 140 or other form of acoustic transducer for transforming audio signals into electrical signals. The apparatus may also include a speaker 150 for generating the audio signal of a user's spoken utterance and the reference (or training) utterances. The apparatus may also include a speech recognizer 110 for analyzing the user's spoken utterance. Finally, the apparatus may include a controller 120 (e.g., a microcontroller or microprocessor). Both the recognizer 110 and controller may be coupled to a memory 130 including a program 135 having instructions that, when executed by the recognizer or controller, cause the recognizer and controller to perform the methods disclosed herein. The speech recognizer may be implemented as hardware, software or a combination of hardware and software. Furthermore, the recognizer may be implemented on the same integrated circuit as the controller.

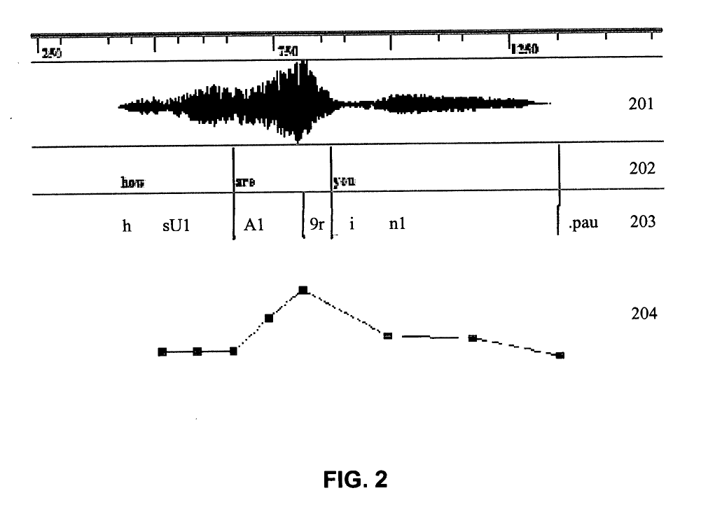

FIG. 2 shows an example utterance and sub-units for the utterance “how are you.” FIG. 2 illustrates the amplitude of a speech utterance 201 as a function of time, the words in the utterance 202, the phonemes in the utterance 203 and the pitch contour 204. As an utterance is received by the system, the utterance 201 may be broken down into sub-units for more detailed analysis. The sub-units may be based on regular or irregular time intervals. An example of this is shown in FIG. 2 at 202 and 203. At 202, the utterance “how are you” is shown under the utterance waveform 201. The phonemes (i.e., sounds) associated with “how are you” are shown at 203. Pitch contour 204 illustrates the pitch associated with each phoneme. Analyzing the utterance may include identifying each sub-unit of sound in the received utterance. Analysis may also include identifying prosody information, which may include some or all of the prosody characteristics identified above. Speech quality of the input utterance may be determined based on how close the sound and prosody information is to a reference value (e.g., a reference utterance).

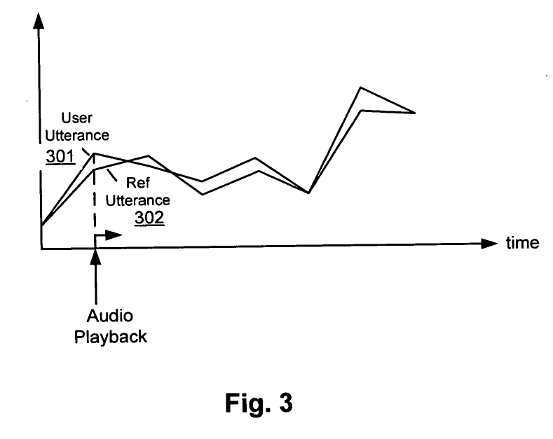

FIG. 3 illustrates simultaneous display and playback according to one embodiment of the present invention. In this embodiment, the display may be a plot on a display such as a monitor, a liquid crystal display (“LCD”) or equivalent display technology. The display includes a plot of the user's utterance 301 as a function of time and a reference utterance 302 as a function of time. As the user's input utterance is played back (e.g., through a speaker as an audio signal), one possible display technique may include showing an arrow on the screen that moves across the plotted waveforms synchronously with the playback so the person can see the speech quality as the particular portion of speech is generated. Another display technique may include incrementally displaying the plot as the utterance is played back. Thus, at a certain time during playback, only the portion of the plot corresponding to the portion of the utterance that has already been played back will be displayed. As additional portions of the utterance are played back, the plot is incrementally updated so that the user is seeing the plot generated simultaneously as the utterance is generated.

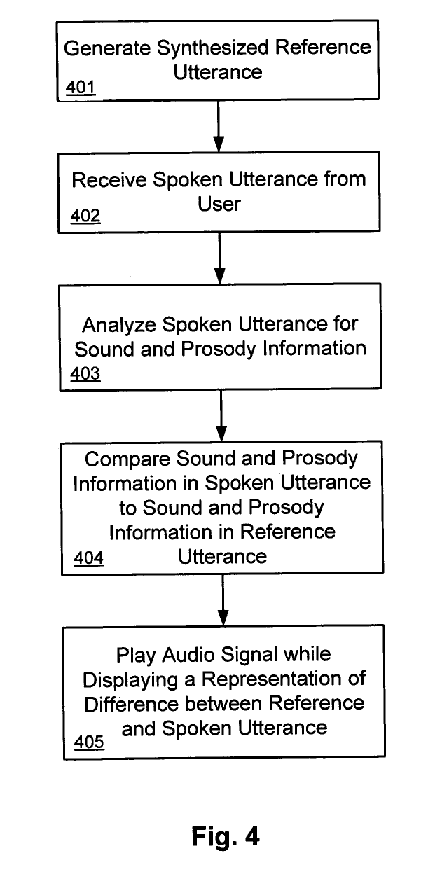

FIG. 4 illustrates a pronunciation training method according to one embodiment of the present invention. At step 401, the system generates a synthesized reference utterance. For example, a reference utterance may be stored in the system and be played to a user to give the user a reference as to the proper pronunciation of a certain phrase. The user may be prompted by synthesized speech from the pronunciation trainer on the proper pronunciation of a phrase. At step 402, the system receives the spoken utterance of the user, which may be the user's best attempt to repeat the reference utterance. At step 403, the system analyzes the spoken utterance for sound and prosody information. For example, the system may analyze the utterance for some or all of the prosody information identified above. At step 404, the system compares the sound and prosody information in the spoken utterance to sound and prosody information in the reference utterance. In one embodiment, the system compares sound and prosody information for sub-units of the spoken utterance to sound and prosody information for corresponding sub-units of the reference utterance. Accordingly, the speech quality of the user's utterance may be determined. At step 405, the system plays back the user's spoken utterance (i.e., generates an audio signal of the spoken utterance) while simultaneously displaying a representation of the difference between the reference utterance and the user's spoken utterance. This difference may be the difference between the sound and prosody information of each sub-unit, for example. Moreover, the user's spoken utterance may be generated synchronously with the displaying of the representation of the difference between the sound and prosody information of each sub-unit.

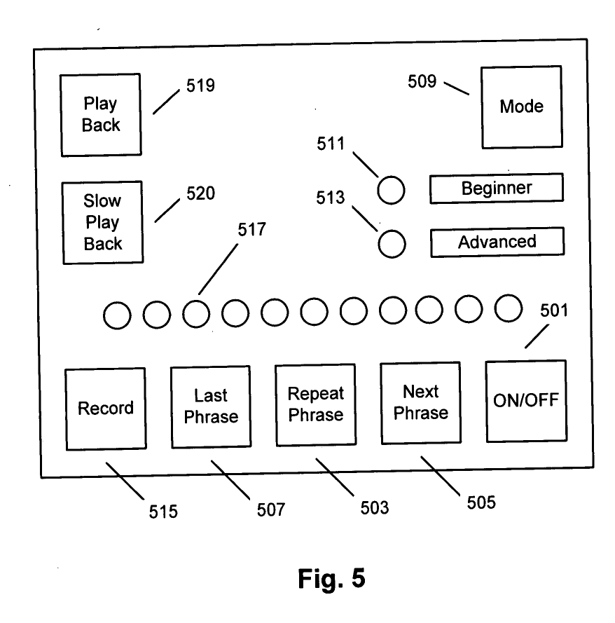

FIG. 5 is a specific example of a hand-held pronunciation trainer according to one embodiment of the present invention. It is to be understood that the features and functions described below could be implemented in a variety of different ways and that a system may use some or all of the features included in this example. The description of its operation as a device that measures the speech quality of thirty-four (34) phrases is given below. Pronunciation trainer may be used to teach a user both the meaning and the pronunciation of common English phrases. When a user selects a phrase to study, pronunciation trainer will speak it in correct English and provide the user with a reference to a translation (e.g., either electronically or manually by telling the user where to look in a pamphlet for the translation of the phrase). Then the user may practice saying the phrase just like he/she heard it. When the user is ready to record the phrase for an evaluation of his/her English pronunciation, pronunciation trainer will record and analyze the user's utterance of the phrase. It will play back the user's recording at either normal or slow speed and show the user where mispronunciations may have occurred. After comparing the user's pronunciation with the correct pronunciation from the English speaker (i.e., a reference utterance), the user can make another recording that will be evaluated as above in order to help improve pronunciation. There are two levels of speech evaluation, ‘beginner’ and ‘advanced.’ A user can move from ‘beginner’ to ‘advanced’ as pronunciation improves. A user can also move to the next or previous phrase to continue with the English lesson.

A user may press the ‘ON/OFF’ button 501 to turn the unit on. Then press the ‘REPEAT PHRASE’ 503 button. The user will hear, ‘One’ and ‘Please say that again’ in a first language (e.g., typically a language that the user wants to learn, such as English). ‘One’ means that this is phrase number one (1). ‘Please say that again’ is the phrase that the user will learn to say. A user may receive a reference to an instruction manual to find the translation of the phrase ‘Please say that again.’ A user may press the ‘REPEAT PHRASE’ 503 button if the user wants to hear the English pronunciation of this phrase again or press the ‘NEXT PHRASE’ 505 or ‘LAST PHRASE’ 507 button to hear the next or previous phrase along with its phrase number. A user may press the ‘MODE’ button 509 to toggle whether the analysis of the user's upcoming recording will be in the ‘BEGINNER’ or ‘ADVANCED’ mode. The lights 511 and 513 below the ‘MODE’ 509 button indicate the mode. In ‘BEGINNER’ mode, the quality of the spoken utterance is evaluated against a lower standard than in the ‘ADVANCED’ mode (i.e., the speech quality can be less in ‘BEGINNER’ mode for a given output). Additional modes, or standards, could also be used. Moreover, the standard used for evaluating the user's spoken utterance may be altered after the spoken utterance is first analyzed so a user can determine his level of sophistication.

After a user selects a phrase and the analysis mode, the user may press and hold down the ‘RECORD’ button 515. A fraction of a second after pressing the ‘RECORD’ button 515, the user may say the phrase of interest. The user may then release the ‘RECORD’ button 515 a moment after finished speaking the utterance. During recording, the row of lights 517 will monitor the loudness of the input speech. If the user speaks too softly or is too far from the unit, only the first one or two lights at the left of the group will come on. If the user speaks too loudly or is too close to the unit, the last red light at the right of the group will come on. In other words, the system may produce a visual output that is used to indicate the amplitude of the user's spoken utterance. Either of these situations will produce a low quality recording, so the user should practice until the speech volume is adjusted to turn on the middle, green lights while speaking.

After the user finishes speaking, the unit will analyze the user's input utterance and report the quality of the pronunciation in the twelve light emitting diodes 517 simultaneously as the spoken utterance is played back. Each of the twelve lights represents a segment of the recorded utterance with the left-to-right arrangement of lights corresponding to the beginning-to-end of the utterance. The light emitting diodes produce different color outputs depending on the accuracy of the user's utterance. If a light is green, that segment of the user's spoken utterance has a good speech quality. If it is yellow, that segment is questionable, while, if it is red, that segment of user's spoken utterance has a poor speech quality. In other words, the colors of the light emitting diodes correspond to the speech quality at successive portions of the user's spoken utterance.

A user can listen carefully for the parts of the recording where the lights are either yellow or red by pressing the ‘PLAY BACK’ button 519. Alternatively, a user can obtain a more precise location of any pronunciation problems in the phrase by pressing the ‘SLOW PLAY BACK’ button 521 and then watching the lights. A user can also hear the correct English pronunciation by pressing the ‘REPEAT PHRASE’ button 503 again. By comparison of the user's spoken utterance with the correct English reference utterance, a user can learn how the poorly spoken parts of his/her spoken utterance may be improved, and the user can improve them by making new recordings.

Embodiments of the present invention may include a variety of phrases. Example phrases that may be used in a system are shown below for illustrative purposes. The following may be included with a system according to the present invention so that a user will have a reference to translate utterances being produced by the system during a pronunciation and language training session. The first phrase is in a first language, which is typically a language the user is trying to learn. These phrases are illustrated by an underscore-one (e.g., “One_{—}1,” in English). The second phrase is in a second language, which is typically a language the user understands (e.g., the user's native language). These phrases are indicated by an underscore-two (e.g., “One_{—}2,” in Chinese)

THE PHRASES

| | |
|---|---|
| One_1 | Please say that again. |
| One_2 | Please say that again. |
| Two_1 | Can you help me? |
| Two_2 | Can you help me? |
| Three_1 | Where's the restroom? |
| Three_2 | Where's the restroom? |
| Four_1 | Thank you. |
| Four_2 | Thank you. |
| Five_1 | Are you married? |
| Five_2 | Are you married? |
| Six_1 | Hello. |
| Six_2 | Hello. |
| Seven_1 | I'm sorry. |
| Seven_2 | I'm sorry. |
| Eight_1 | Can you show it to me on the map? |
| Eight_2 | Can you show it to me on the map? |
| Nine_1 | Do you know a good restaurant? |
| Nine_2 | Do you know a good restaurant? |
| Ten_1 | You're welcome. |
| Ten_2 | You're welcome. |
| Eleven_1 | I beg your pardon. |
| Eleven_2 | I beg your pardon. |
| Twelve_1 | Good evening. |
| Twelve_2 | Good evening. |
| Thirteen_1 | I love you. |
| Thirteen_2 | I love you. |
| Fourteen_1 | I'd like to make a phone call. |
| Fourteen_2 | I'd like to make a phone call. |
| Fifteen_1 | One, two, three, four, five. |
| Fifteen_2 | One, two, three, four, five. |
| Sixteen_1 | I'm looking for a bank. |
| Sixteen_2 | I'm looking for a bank. |
| Seventeen_1 | It's on me. |
| Seventeen_2 | It's on me. |
| Eighteen_1 | Merry Christmas. |
| Eighteen_2 | Merry Christmas. |
| Nineteen_1 | I don't speak English. |
| Nineteen_2 | I don't speak English. |
| Twenty_1 | I want two hamburgers. |
| Twenty_2 | I want two hamburgers. |
| Twenty one_1 | Please write that down. |
| Twenty one_2 | Please write that down. |
| Twenty two_1 | I'm here on business. |
| Twenty two_2 | I'm here on business. |
| Twenty three_1 | Check, please. |
| Twenty three_2 | Check, please. |
| Twenty four_1 | That's fantastic. |
| Twenty four_2 | That's fantastic. |
| Twenty five_1 | I'd like a room. |
| Twenty five_2 | I'd like a room. |
| Twenty six_1 | What did you say? |
| Twenty six_2 | What did you say? |
| Twenty seven_1 | How do you do? |
| Twenty seven_2 | How do you do? |
| Twenty eight_1 | Excuse me. |
| Twenty eight_2 | Excuse me. |
| Twenty nine_1 | What do you recommend? |
| Twenty nine_2 | What do you recommend? |
| Thirty_1 | I don't understand. |
| Thirty_2 | I don't understand. |
| Thirty one_1 | What time is it? |
| Thirty one_2 | What time is it? |
| Thirty two_1 | What's the price of my stock? |
| Thirty two_2 | What's the price of my stock? |
| Thirty three_1 | Can you please give me directions? |
| Thirty three_2 | Can you please give me directions? |
| Thirty four_1 | How are you? |
| Thirty four_2 | How are you? |

The pronunciation trainer may also provide audio feedback that explains situations that arise during its use. For example, the analysis of a user's utterance may not be reliable if the user's speech volume was not large enough compared to the background noise. In this case, the pronunciation trainer may say, “Please talk louder or move to a quieter location.” Embodiments of the present invention may work better in a quiet location. If the noise level is too large for a reliable analysis of the user's recording, the pronunciation trainer may say, “This product will work better if you move to a quiet location.” If the user's utterance is distorted during playback, the user may have spoken too loudly, so the unit might say “Please talk louder while watching the lights.” If only part of the spoken utterance is played back, the a user may have paused in the middle of the recording for a long enough time that pronunciation trainer thought the user was done speaking. In this case, the user may be prompted with a phrase suggesting that the pauses in his recording should be shorter.

### EXAMPLE

The following describes an example of one speech recognizer that may be used in embodiments of the present invention. The speech recognizer used in this specific embodiment, and features of the description that follows should not be imported into the claims or definitions of the claim elements unless specifically so stated by this disclosure. Additional support for some of the concepts describe below may be found in commonly-owned U.S. patent application Ser. No. 10/866,232, entitled Method and Apparatus for Specifying and Performing Speech Recognition Operations, filed Jun. 10, 2004 naming Pieter J. Vermeulen, Robert E. Savoie, Stephen Sutton and Forrest S. Mozer as inventors, the contents of which is hereby incorporated herein by reference in its entirety. Any definitions of any claim terms provided in the present disclosure take precedence over definitions in U.S. patent application Ser. No. 10/866,232 to the extent any such definitions are conflicting or related.

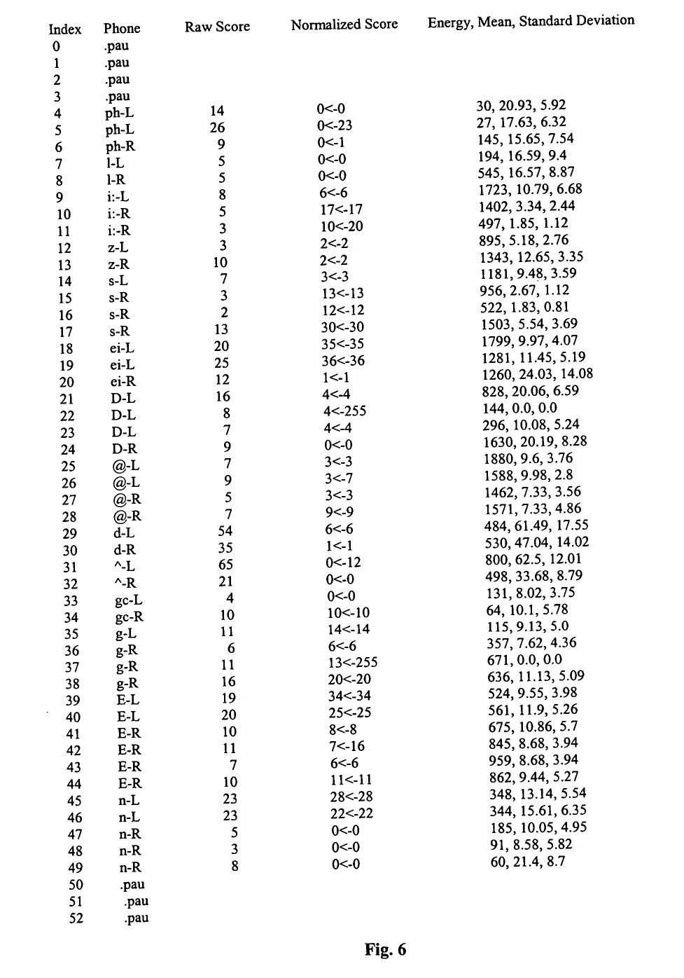

The operation of a pronunciation trainer according to one example implementation may be understood by reference to FIG. 6, which is a table of output data produced by a speech recognizer that may be embedded in the system. The index column of this figure corresponds to successive 27 millisecond blocks of analyzed data. The second column of this figure gives the “phone” identified by the recognizer as being the most probable for that block of data. A “phone” is defined as a part of a phoneme (a sound of the English language), where each phoneme is considered to have a left part, designated by the letter “L” in the phone name, and a right part, designated by the letter “R.” The phrase being analyzed is “Please say that again” and the phonemes in the words of this phrase are /ph 1 i: z/; /s ei/; /D @ d/; and /ˆ g E n/. Note that the last phone in the word “that” is /d/ and not /t/ because it links to the beginning of the next word to sound like a /d/ not a /t/. Thus, the correct pronunciation of each sound depends on its neighbors, which is why there is a left context and a right context to each phoneme. The phone /.pau/ signifies the silence before and after the phrase was spoken.

The third column of data in FIG. 6 is the negative of the log of the probability that the block of data under consideration is the phone that is identified with it. Thus, bigger raw scores correspond to poorer fits of the data to the identified phone. The raw scores are interpreted by post-processing to produce the normalized scores in the fourth column of this figure, where the normalized scores may be used to determine the displayed output such as, for example, the colors of the light emitting diodes that the user sees as the recording is played back.

The fifth column of the figure gives the data used to normalize the raw scores. Each row of this column contains three numbers, the first of which is the energy associated with that block of data, where a bigger number corresponds to a louder volume of that segment of speech. The second and third numbers are the means and standard deviations of the raw scores of the corpus of good speakers who recorded the same phrase. These means and standard deviations are segregated by the triples of phones. That is, the raw scores for each good speaker whose preceding phone, current phone and following phone were the same were accumulated and the means and standard deviations of this accumulation were computed off-line. Thus, for example, the mean and standard deviation of all speakers who said /l-R/ followed by /i:-L/, followed by /i:-R/ was computed to be 10.79 and 6.68, as can be seen in the data associated with block 9.

The raw scores for each block were converted to a normalized score, which is the right-most number of column 4 using the equation,
normalized score=10+10*(raw score−mean)/(standard deviation)
Thus, the normalized score of block 9 is 6 because the raw score was less than the mean score (10.79) by a fraction of the standard deviation (6.68).

There are two corrections to the normalized scores that are produced as described above. The first occurs for cases where there were not sufficient examples of a triple in the corpus of the good speakers to produce a reliable mean and standard deviation. When this happens, as for blocks 22 and 37, the normalized score is recorded as 255. In a second normalization, this score is replaced by the average of the scores on either side of it. Thus, for example, the final normalized score for block 37, given as the first number in the normalized score column, is the average of 6 and 20, or 13.

Because the distribution of scores of phone triples is not a normal distribution, there are sometimes outliers that produce large normalized scores. This happens in the case of block 11 because the mean and standard deviation for this triple are small. Thus, even though the raw score for this block was small (3), it was a standard deviation above the mean of the corpus of good speakers, so the first normalized score was 20. To handle such cases that usually arise from small standard deviations, the normalized score of any block is replaced by the average of the normalized scores of its neighbors if it is two or more times larger than the average of its neighbors. Thus, the final normalized score of block 11 became 10.

The importance of normalizing the raw scores is evidenced by the data of blocks 29, 30, and 31, all of which produced raw scores that were large. However, the mean and standard deviation of block 29 for example, was 61.49 and 17.55, so the raw score of 54 was less than the mean, resulting in a normalized score of 6.

The final normalized scores are averaged to produce 12 values that control the 12 light emitting diodes 517 of FIG. 5. For the data of FIG. 6, the average scores are all sufficiently small that all 12 of the light emitting diodes were green successively as the phrase was played. An example where this does not occur is discussed next.

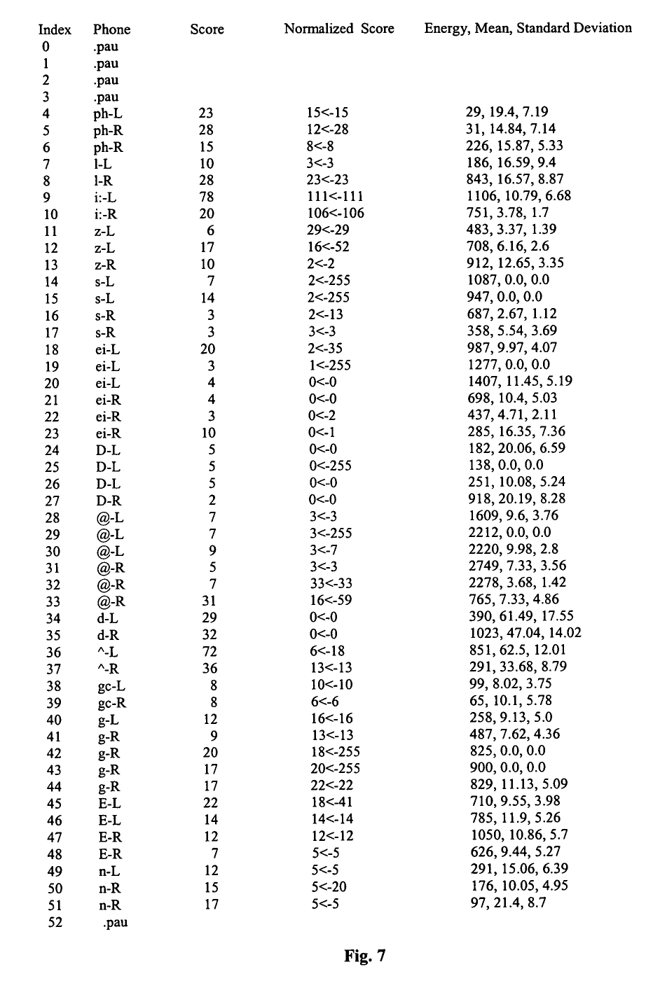

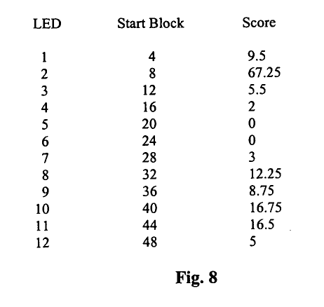

FIG. 7 presents data analogous to that of FIG. 6, except that the speaker said “pliz” that rhymes with “his” instead of “please” that rhymes with “cheese.” Thus, one expects that the vowel in the first word of the phrase should score poorly, as it does at blocks 9 and 10. FIG. 8 is the average scores from the data of FIG. 7. The data of FIG. 8 results from averaging the final normalized data of FIG. 7 to 12 values. It is seen that the second of the 12 scores is poor, indicating that there was a problem with the phonetic pronunciation about 10% of the way through the user's recording.

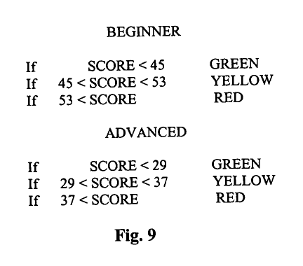

FIG. 9 is a scoring table that may be used in displaying speech quality in one specific example implementation. For example, the scoring table may be used for determining if the light emitting diodes are green, yellow, or red. The data in FIG. 8 may be used to determine the colors of each of the twelve output light emitting diodes. For example, conversion of the scores of FIG. 8 into the three colors of the light emitting diodes may be done through the table of FIG. 9, from which it is seen that the score of 67.25 associated with the second light emitting diode will cause that diode to be red regardless of whether the mode is set to “beginner” or “advanced.” Thus, as the user's phrase is played back, the first light emitting diode shows green as the first part of the first word is spoken. Then, during the second part of the first word, the second light emitting diode comes on red to indicate a problem with the pronunciation of the vowel in the first word. From then on, through the remainder of the playback of the user's phrase, successive light emitting diodes come on and they are all green because no score is above the threshold that turns these light emitting diodes to yellow. To further spot the problem as the vowel in the first word, the user can play back his recording at a slow speed while watching the second light emitting diode turn red. He can then compare his recording to that of the professional speaker and realize that he said “Pliz” while the professional speaker said “Please.” The user can than make a new recording where he is careful about the pronunciation of the vowel in the first word, and he thereby learns to better pronounce this phrase.

The above description of example embodiment concerns teaching a user to correct the phonetic pronunciation of his speech. However, good English also requires that the emphasis and duration of the sub-units of a phrase be correct. In another embodiment, the speech recognizer analyzes the relative duration of different parts of an utterance. For example, the durations of the phones in FIGS. 6 and 7 can be compared with those of the average of the speakers in the corpus, and the user can get feedback on the durations of his phones by watching the light emitting diodes as the phrase is played back. These diodes would be red if the duration of a segment of the recording was too long, green if it was appropriate and yellow if it was too short.

In yet another description of a preferred embodiment, the prosody of the user's phrase can be compared to the average of that for the corpus of good speakers. Prosody may consists of emphasis, which is the amplitude of the speech at any point in the phrase, and the pitch frequency as a function of time. The amplitude of the speech is given in FIGS. 6 and 7, so the light emitting diodes can measure emphasis as compared to that of the corpus of expert speakers by making the light emitting diodes red if the user's relative amplitude is too large, green if it is appropriate and yellow if it is too small. Additionally, a conventional pitch detector can run in parallel with the speech recognizer to measure the pitch as a function of time, and the light emitting diodes can be red if the relative pitch is too high during some portion of the phrase, green if it is appropriate and yellow if it is too low.

Likewise, in another description of the preferred embodiment, the placement of the lips and tongue, and their variations during the playback of the phrase, can be displayed so the user can see how to form the vocal cavity for any portion of the phrase that is mispronounced. For example, the placement of the lips and tongue that form the vocal cavity may be displayed in synchronization with the playback of the user's spoken utterance or the synthesized reference utterance.

Because the cost of on-board memory in a small hand-held device limits the number of phrases that can be stored in the device at any one time, a hand-held unit may include a memory (e.g., a programmable memory) such that many different vocabularies containing different reference utterances for training can be downloaded from an external source sequentially to produce a large amount of training material. Each such vocabulary might contain a few dozen phrases covering special topics such as business, sports, games, slang, etc.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims. The terms and expressions that have been employed here are used to describe the various embodiments and examples. These terms and expressions are not to be construed as excluding equivalents of the features shown and described, or portions thereof, it being recognized that various modifications are possible within the scope of the appended claims.

What is claimed is:

1. A computer-implemented pronunciation training method comprising:
receiving a spoken utterance from a user, the spoken utterance including a plurality of sub-units of sound;
analyzing the speech quality of the plurality of sub-units of sound of the spoken utterance; and
generating an audio signal of the spoken utterance from the user while simultaneously displaying the speech quality of each sub-unit of the spoken utterance as each sub-unit of the spoken utterance is generated.

2. The method of claim 1 further comprising prompting a user on the proper pronunciation of an utterance.

3. The method of claim 1 wherein the sub-units of sound include phonemes.

4. The method of claim 1 wherein the sub-units of sound include phones.

5. The method of claim 1 wherein the displaying uses a plurality of light emitting diodes.

6. The method of claim 5 wherein the plurality of light emitting diodes produce different color outputs, and the colors of the light emitting diodes correspond to the speech quality at successive portions of the spoken utterance.

7. The method of claim 1 wherein the displaying uses a liquid crystal display.

8. The method of claim 1 wherein the speech quality is analyzed by a speech recognizer.

9. The method of claim 8 wherein the speech recognizer analyzes the phonemes in the spoken utterance.

10. The method of claim 8 wherein the speech recognizer analyzes prosody of the spoken utterance.

11. The method of claim 10 wherein the prosody includes pitch.

12. The method of claim 10 wherein the prosody includes emphasis.

13. The method of claim 8 wherein the speech recognizer analyzes the relative duration of different parts of the utterance.

14. The method of claim 8 wherein the output of the speech recognizer is normalized using a corpus of utterances.

15. The method of claim 1 wherein the placement of the lips and tongue that form the vocal cavity is displayed in synchronization with the generating the audio signal of the spoken utterance.

16. The method of claim 1 wherein the quality of the spoken utterance is evaluated against two or more standards.

17. The method of claim 1 wherein the standard used for evaluating the spoken utterance may be altered after the spoken utterance is first analyzed so a user can determine his level of sophistication.

18. The method of claim 1 further comprising producing a visual output that is used to indicate an amplitude of the spoken utterance.

19. A computer-implemented pronunciation training method comprising:
generating a synthesized reference utterance, the reference utterance including a plurality of sub-units of sound;
receiving a spoken utterance from a user, the spoken utterance including a plurality of sub-units of sound;
analyzing the spoken utterance from the user for sound and prosody information;
comparing sound and prosody information of the each of the sub-units of the spoken utterance to sound and prosody information for corresponding sub-units of the reference utterance; and
generating an audio signal of the spoken utterance from the user while simultaneously displaying a representation of the difference between the sound and prosody information of each sub-unit,
wherein the audio signal of the spoken utterance is generated synchronously with the displaying of the representation of the difference between the sound and prosody information of each sub-unit.

20. The method of claim 19 wherein the sub-units of sound include phonemes.

21. The method of claim 19 wherein the sub-units of sound include phones.

22. The method of claim 19 wherein the displaying uses light emitting diodes.

23. The method of claim 19 wherein the displaying uses a liquid crystal display.

24. The method of claim 19 wherein the speech quality is analyzed by a speech recognizer.

25. The method of claim 24 wherein the speech recognizer analyzes the phonemes in the spoken utterance.

26. The method of claim 24 wherein the speech recognizer analyzes prosody of the spoken utterance.

27. The method of claim 26 wherein the prosody includes pitch.

28. The method of claim 26 wherein the prosody includes emphasis.

29. The method of claim 24 wherein the speech recognizer analyzes the relative duration of different parts of the utterance.

30. The method of claim 24 wherein the output of the speech recognizer is normalized using a corpus of utterances.

31. The method of claim 19 wherein the placement of the lips and tongue that form the vocal cavity is displayed in synchronization with the generating the audio signal of the spoken utterance.

32. The method of claim 19 wherein the quality of the spoken utterance is evaluated against two or more standards.

33. The method of claim 19 wherein the standard used for evaluating the spoken utterance may be altered after the spoken utterance is first analyzed so a user can determine his level of sophistication.

34. The method of claim 19 further comprising producing a visual output that is used to indicate an amplitude of the spoken utterance.

35. An apparatus for pronunciation training comprising:
a microphone;
a speaker;
a display;
a speech recognizer; and
a controller, the controller including a program for performing a method comprising:
receiving a spoken utterance from a user, the spoken utterance including a plurality of sub-units of sound;
analyzing the speech quality of the plurality of sub-units of sound of the spoken utterance; and
generating an audio signal of the spoken utterance from the user while simultaneously displaying the speech quality of each sub-unit of the spoken utterance as each sub-unit of the spoke utterance is generated.

36. The apparatus of claim 35 wherein said apparatus is a hand-held device.

37. The apparatus of claim 35 further comprising a memory for storing reference utterances.

38. The apparatus of claim 37 wherein the reference utterances may be downloaded from an external source.

39. The apparatus of claim 35 the method further comprising prompting a user on the proper pronunciation of an utterance.

40. The apparatus of claim 35 wherein the sub-units of sound include phonemes.

41. The apparatus of claim 35 wherein the sub-units of sound include phones.

42. The apparatus of claim 35 wherein the displaying uses a plurality of light emitting diodes.

43. The apparatus of claim 42 wherein the plurality of light emitting diodes produce different color outputs, and the colors of the light emitting diodes correspond to the speech quality at successive portions of the spoken utterance.

44. The apparatus of claim 35 wherein the displaying uses a liquid crystal display.

45. The apparatus of claim 35 wherein the speech quality is analyzed by a speech recognizer.

46. The apparatus of claim 45 wherein the speech recognizer analyzes the phonemes in the spoken utterance.

47. The apparatus of claim 45 wherein the speech recognizer analyzes prosody of the spoken utterance.

48. The apparatus of claim 47 wherein the prosody includes pitch.

49. The apparatus of claim 47 wherein the prosody includes emphasis.

50. The apparatus of claim 45 wherein the speech recognizer analyzes the relative duration of different parts of the utterance.

51. The apparatus of claim 45 wherein the output of the speech recognizer is normalized using a corpus of utterances.

52. The apparatus of claim 35 wherein the placement of the lips and tongue that form the vocal cavity is displayed in synchronization with the generating the audio signal of the spoken utterance.

53. The apparatus of claim 35 wherein the quality of the spoken utterance is evaluated against two or more standards.

54. The apparatus of claim 35 wherein the standard used for evaluating the spoken utterance may be altered after the spoken utterance is first analyzed so a user can determine his level of sophistication.

55. The apparatus of claim 35 the method further comprising producing a visual output that is used to indicate an amplitude of the spoken utterance.
